(19) United States
(12) Patent Application Publication
(10) Pub. No.: US 2025/0296651 A1
(43) Pub. Date: Sep. 25, 2025

(54) MOTORCYCLE WITH IMPROVED AERODYNAMICS

(71) Applicant: PIAGGIO & C. S.P.A., Pontedera (IT)

(72) Inventor: Marco DE LUCA, Pontedera (IT)

(21) Appl. No.: 18/869,488

(22) PCT Filed: May 26, 2023
(86) PCT No.: PCT/IB2023/055420

§ 371 Date: Nov. 26, 2024

(30) Foreign Application Priority Data
May 27, 2022 (IT) 102022000011312

(51) Int. Cl. B62J 17/10

(52) U.S. Cl. CPC B62J 17/10

(57) ABSTRACT

Motorcycle (100) comprising a rear portion (20) equipped with a spoiler (2), said rear portion (20) being arranged above the rear wheel and being covered by a fairing (40). said spoiler (2) being attached to an upper side of the fairing (40).

### TECHNICAL FIELD

The present invention relates to the field of motorcycles. Preferably, the present invention relates to “road” or “street” motorcycles. Even more preferably, the present invention relates to racing motorcycles, in particular for top of the range competitions such as MotoGP™.

### BACKGROUND ART

The application of aerodynamic appendages is known in the automotive sector. The spoiler is an aerodynamic element arranged on the rear end of motor vehicles and used to obtain greater grip.

In particular, the spoiler has the function of increasing the aerodynamic downforce of the motor vehicle, thereby increasing the total drag coefficient and, in this way, ensuring greater grip, both on corners and on the straight, above all at high speeds.

Remaining in the automotive sector, spoilers of fixed or active type are known. The latter are shaped to move between a retracted configuration, in which they are inside the body of the rear end of the vehicle, and an open configuration, substantially extending from the rear end body. In general, spoiler opening is controlled automatically based on the speed of the vehicle; it opens when a specific speed threshold is exceeded.

In the motorcycle sector, road sport motorcycles comprise a tail portion on the rear end, also referred to as large tail. The structure or shape of the tail allows guiding of the aerodynamic flow of air over the fairing of the motorcycle from the front end toward the rear end, in order to reduce aerodynamic drag. An example is disclosed in the document EP2722264B1.

Remaining in the two-wheeled vehicle sector, but referring to scooters, the application of rear or lateral spoilers is known, but having a completely different function. Examples are disclosed in the documents EP1944226B1 or EP1944227B1, which disclose a scooter equipped with a spoiler to eliminate the effect of turbulence created by flow of air over the fairing of the scooter.

In the light of what is known, in sport motorcycles of the latest generation there is the need to increase and improve the stability of the motorcycle during high speed travel on the straight or during deceleration before and during the corner, ensuring greater grip of the tyres.

### SUMMARY

A first object of the present invention is to provide a motorcycle comprising a rear portion equipped with a spoiler, said rear portion being arranged above the rear wheel and being covered by a fairing, said spoiler being attached to an upper side of the fairing. In this way, the spoiler allows an aerodynamic force to be created on the rear wheel. This force is effective above all during trail braking, i.e., sudden braking, and is such as to reduce bouncing of the rear wheel, improving the grip of the bike and thus facilitating entering the corner. Moreover, the greater load that is created on the rear end of the motorcycle is useful in undulating straight stretches, such as a downhill stretch, in which the motorcycle reaches a speed of around 350 Km/h and would tend to lose grip. This solution also allows improvement of the balance of the motorcycle, and therefore wear of the tyres. Better grip is also obtained during braking when both tyres are in contact with the ground.

Preferably, said spoiler can be arranged in a distal position of the rear portion of the motorcycle positioned behind the driving seat. In this way, the distal position of the spoiler, i.e., in an end position of the rear end, is such as to minimize the turbulences that are created behind the driver and exploit a flow that is as linear as possible so as to obtain a greater aerodynamic force.

Advantageously, the spoiler can comprise a vertical portion that extends upwards from the fairing of the rear portion and a transverse portion that extends laterally from the top of the vertical portion symmetrically to the right and left with respect thereto. This T-shape is structurally suitable to generate a balanced aerodynamic force on the rear wheel.

In particular, the transverse portion has an airfoil profile comprising a substantially straight leading edge and a curved trailing edge. In this way, the flow of air over the transverse portion of the spoiler generates a weighted aerodynamic force in the order of a few kilograms on the rear wheel.

Advantageously, the fairing of the rear portion comprises two wings connected to a central portion of the fairing of the rear portion. In this way, the wings of the rear fairing form, with the central portion, respective aerodynamic channels, on opposite sides of the fairing, which allow an improved aerodynamic flow on the rear end.

Preferably each wing can comprise a lateral portion that extends laterally from the fairing of the rear portion. Said lateral portion being shaped to extend in a front-back direction. Each lateral portion comprises a leading edge of the lateral portion and a trailing edge of the lateral portion arranged on the opposite side according to a front-back direction. In particular, the leading edge of the wing is lower than the trailing edge with respect to the ground observing the motorcycle from the side. In this way, the inclined shape of the lateral wings also allows the generation of a aerodynamic downforce at the fairing of the rear portion, at a distance below that of the spoiler.

In particular, each wing can comprise a vertical portion that extends upwards from the distal end of the lateral portion of the wing. These vertical portions improve channelling of the air that flows over the motorcycle, reducing turbulences behind the motorcycle.

Advantageously, the fairing of the rear portion can comprise a trailing edge having a flattened shape and a width at least four times greater than the height thereof. This shape of the trailing edge of the fairing allows better grip of the motorcycle to the ground, and a better separation of the fluid that flows over the motorcycle at high speeds.

In particular, the trailing edge of the fairing of the rear portion can incorporate the trailing edge of the lateral portion of the wing. In particular, the trailing edge of the fairing of the rear portion is contiguous, on opposites sides to each other, with the trailing edges of the lateral portion of the wing. This shape further optimizes the aerodynamics of the motorcycle.

Preferably, the width of the spoiler can be substantially equal to the width of the trailing edge of the fairing of the rear portion. In this way, the aerodynamic force generated by the spoiler and by the lateral wings is balanced at different distances from the ground.

These and other advantages will be apparent in more detail from the description below of an exemplary embodiment, provided by way of non-limiting example with reference to the accompanying drawings.

### DESCRIPTION OF THE DRAWINGS

In the drawings:

FIG. 1 illustrates a perspective front view of the rear portion of a motorcycle;

FIG. 2 illustrates a perspective rear view of the rear portion of a motorcycle.

### DETAILED DESCRIPTION

The following description of one or more embodiments of the invention refers to the accompanying drawings. The same reference numbers in the drawings identify the same or similar elements. The subject matter of the invention is defined by the appended claims. The technical details, structures or features of the solutions described below can be combined with one another in any manner.

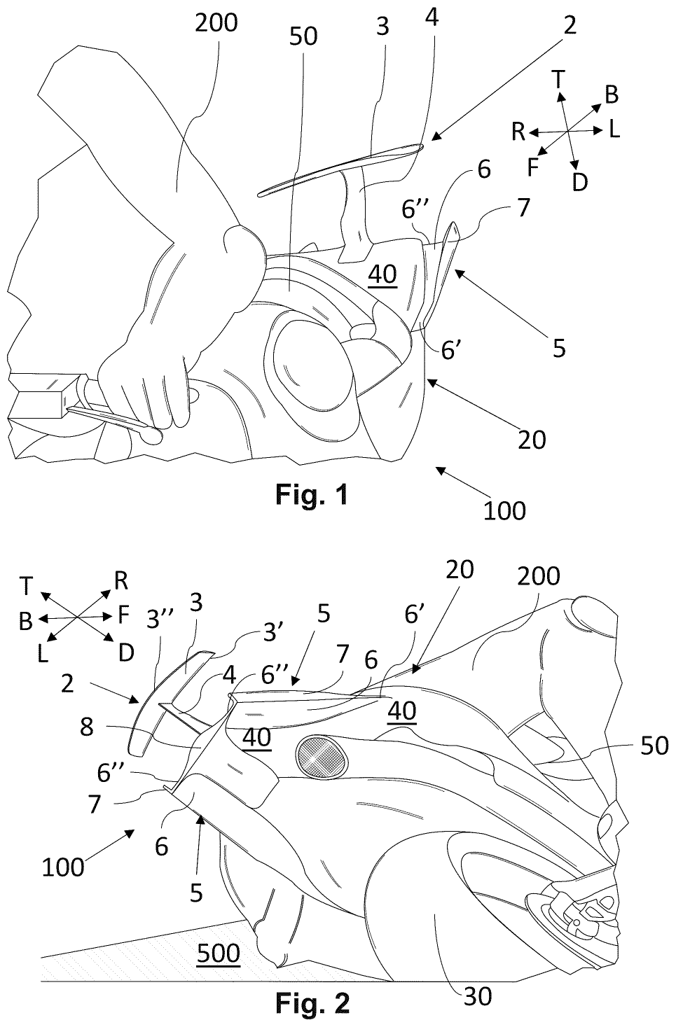

In FIGS. 1 and 2, the reference number 100 illustrates a motorcycle. The motorcycle 100 illustrated is a racing motorcycle in which a driver 200 can be identified. The driver 200 is positioned on the driving seat 50.

The motorcycle 100 comprises a front wheel (not illustrated), an engine (not illustrated) and a rear wheel 30.

The motorcycle 100 further comprises a frame that extends longitudinally and that connects, directly or indirectly, the aforesaid elements of the motorcycle 100 to one another.

The frame 100 is concealed at least in part by a fairing shaped to improve the aerodynamics of the motorcycle 100.

The motorcycle 100 comprises a front portion (not illustrated) comprising the front wheel (not illustrated) and a rear portion (20) mounted over the rear wheel 30.

The rear portion 20 is arranged behind the driving seat 50.

The terms “behind” and “in front” refer to the longitudinal front-back direction (F-B) of the motorcycle 100 illustrated in FIGS. 1 and 2.

The terms “laterally” or “at the side” refer to the right-left transverse direction (R-L) of the motorcycle 100 illustrated in FIGS. 1 and 2.

The term “upward” refers to the top-down direction (T-D) of the motorcycle 100 illustrated in FIGS. 1 and 2.

The part of fairing that covers the rear portion 30 is indicated with the reference number 40.

The fairing 40 of the rear portion 20, hereinafter indicated as fairing 40 for brevity, is equipped with a spoiler 2.

The spoiler 2 is arranged in a rearward position of the rear portion 20 that lies toward the tergal area of the motorcycle 100. This position is behind the driving seat 50.

The spoiler 2 is attached to the upper side of the fairing 40 and extends upwards.

The spoiler 2 is located behind the driver's back 200 when the driver is driving the motorcycle 100. This positioning of the spoiler 2 is counterintuitive, since the driver 200 shields the spoiler 2 from the flow of air that is created with the forward movement of the motorcycle. However, as the driver 200 is often leaning forward over the motorcycle 100, both on the straight and on corners, the spoiler 2 is able to provide a downforce effect to the motorcycle 100 when it needs this most, i.e. on the straight at high speed or during braking, when the motorcycle 100 tends to have a forward pitching motion.

The spoiler 2 comprises a vertical portion 4 that extends upwards from the fairing 40, like the dorsal fin of a dolphin.

The spoiler 2 further comprises a transverse portion 3 that extends transversely, both to the right and to the left, with respect to the vertical portion 4. The transverse portion 3 is arranged at the top of the vertical portion 4.

The transverse portion 3 has an airfoil profile comprising a leading edge 3′ and a trailing edge 3″. The leading edge 3′ is substantially rectilinear, i.e., straight. The trailing edge 3″ is curved and has a convexity facing the rear of the motorcycle 100.

The fairing 40 is substantially tapered toward the rear of the motorcycle 100.

The fairing 40 comprises two wings 5 connected to said fairing 40. The wings 5 are connected to a central portion of the fairing 40.

Each wing 5 comprises a lateral portion 6 and a vertical portion 7.

The lateral portion 6 extends laterally from the fairing 40 and the root thereof is monolithically connected to the fairing 40. Moreover, the lateral portion 6 extends longitudinally. In particular, each wing 5 comprises a leading edge 6′ and a trailing edge 6″ opposite the leading edge 6′ in the front-back direction. In particular, the leading edge 6′ of the wing 6 is closer to the ground 500 than the trailing edge 6″ thereof.

The vertical portion 7 of each wing 5 extends upwards from the distal end, i.e., from the end farthest from the fairing 40, of the wing 5. In substance, the wings 5 have a section with an L-shaped profile.

The fairing 40 in turn comprises a tapered profile that terminates with a trailing edge 8. This trailing edge, shown in FIG. 2, also incorporates the trailing edges 6″ of the wings 5. In other words, the trailing edge 8 of the fairing 40 and the respective trailing edges 6″ of the wings 5 are at a same height defining a single and contiguous trailing edge profile of the flow of air.

In the central part, the trailing edge 8 of the fairing 40 has a thickening. Notwithstanding this, the width of the trailing edge 8 is much greater than its height, so that the trailing edge 8 of the fairing 40 has a flattened shape.

In particular, this flattened shape of the trailing edge 8 has a width that is from four to eight times the height thereof.

Observing the motorcycle 100 from behind, as in FIG. 2, it can be noted that the width, in right-left direction, of the spoiler 2 corresponds substantially to the width of the trailing edge 8 of the fairing 40.

In conclusion, it is clear that the invention thus conceived is susceptible to numerous modifications or variations, all falling within the scope of the invention; moreover, all details can be replaced by technically equivalent elements. In practice, the quantities can be varied according to technical requirements.

In the claims:

1. A motorcycle comprising a rear portion with a spoiler, the rear portion being arranged above a rear wheel and the rear wheel being covered by a fairing of the rear portion, the spoiler being attached to an upper side of the fairing of the rear portion,
wherein the fairing of the rear portion comprises two wings connected to a central portion of the fairing of the rear portion,
wherein each wing comprises a lateral portion that extends laterally from the fairing of the rear portion; the lateral portion being shaped to extend in a front-back direction and comprising a leading edge of the lateral portion and a trailing edge of the lateral portion,
wherein a trailing edge of the fairing of the rear portion incorporates the trailing edge of the lateral portion of the wing.

2. The motorcycle according to claim 1, wherein the spoiler is arranged in a distal position of the rear portion of the motorcycle, the rear portion being positioned behind a driving seat.

3. The motorcycle according to claim 1, wherein the spoiler comprises a vertical portion that extends upward from the fairing of the rear portion and a transverse portion that extends laterally from a top of the vertical portion symmetrically to the right and left with respect thereto.

4. The motorcycle according to any of the preceding claims claim 3, wherein the transverse portion has an airfoil profile comprising a substantially straight leading edge and a curved trailing edge.

5. The motorcycle according to claim 1, wherein the leading edge of each wing is closer to the ground (500) than the trailing edge.

6. The motorcycle according to claim 1, wherein each wing includes a vertical portion that extends upwards from a distal end of the lateral portion of the wing.

7. The motorcycle according to claim 1, wherein the trailing edge of the fairing of the rear portion has a flattened shape and a width at least four times greater than a height thereof.

8. The motorcycle according to claim 1, wherein a width of the spoiler is substantially equal to a width of the trailing edge of the fairing of the rear portion.
